(19) United States
(12) Patent Application Publication
(10) Pub. No.: US 2025/0350303 A1
(43) Pub. Date: Nov. 13, 2025

(54) HIGH-FREQUENCY MODULE

(71) Applicant: Murata Manufacturing Co., Ltd., Nagaokakyo-shi (JP)

(72) Inventors: Yuudai TANOUE, Nagaokakyo-shi (JP); Masayuki MAEZAWA, Nagaokakyo-shi (JP); Syuichi ONODERA, Nagaokakyo-shi (JP); Minoru IWANAGA, Nagaokakyo-shi (JP); Akira OGASAWARA, Nagaokakyo-shi (JP); Morio TAKEUCHI, Nagaokakyo-shi (JP)

(73) Assignee: Murata Manufacturing Co., Ltd., Nagaokakyo-shi (JP)

(21) Appl. No.: 19/278,845

(22) Filed: Jul. 24, 2025

Related U.S. Application Data
(63) Continuation of application No. PCT/JP2023/032822, filed on Sep. 8, 2023.

(30) Foreign Application Priority Data
Feb. 22, 2023 (JP) 2023-026625

(51) Int. Cl. H04B 1/00; H04B 7/0413

(52) U.S. Cl. CPC H04B 1/0053; H04B 7/0413

(57) ABSTRACT

On a module substrate, a module includes first and second filters for a first reception band, a third filter for a second reception band, and a switch that selectively connects the filters to antenna terminals. The module is configured to operate in a first mode to simultaneously transmit a signals from the first band (via the first filter but not the second filter) and the second band (via the third filter), a second mode to transmit only the first band signal (via the first filter but not the second filter), and a third mode to simultaneously transmit two first band signals (via the first and second filters, respectively). A distance between an input terminal of the first filter and the switch is shorter than a distance between an input terminal of the second filter and the switch.

### CROSS-REFERENCE TO RELATED APPLICATIONS

The present application is a continuation of International Application No. PCT/JP2023/032822, filed Sep. 8, 2023, which claims priority to Japanese patent application 2023-026625, filed Feb. 22, 2023, the entire contents of each of which being incorporated herein by reference.

### TECHNICAL FIELD

The present disclosure relates to a high-frequency module.

### BACKGROUND ART

In the field of mobile communication devices such as cellular phones, support for Carrier Aggregation (CA), Dual Connectivity (DC), and the like which use multiple frequency bands or channels simultaneously in order to improve a data rate of a radio link has been in progress. For example, Patent Document 1 discloses a high-frequency circuit that supports E-UTRAN New Radio-Dual Connectivity (EN-DC). Moreover, support for Multiple-Input and Multiple-Output (MIMO) that realizes multipass transmission using multiple antennas has also been in progress.

### CITATION LIST

### Patent Document

Patent Document 1: Japanese Unexamined Patent Application Publication No. 2020-167446

### SUMMARY

### Technical Problems

However, in the related art, there is a case of deterioration in reception sensitivity depending on the mode when supporting the multiple modes including CA, DC, MIMO, and the like.

Given the circumstances, the present disclosure provides a high-frequency module that can suppress deterioration in reception sensitivity.

### Solutions to Problems

A high-frequency module according to an aspect of the present disclosure includes: a module substrate; a first filter and a second filter disposed at the module substrate and having a passband including a reception band of a first band; a third filter disposed at the module substrate and having a passband including a reception band of a second band; and a switch disposed at the module substrate and including a first terminal to be connected to an input terminal of the first filter, a second terminal to be connected to an input terminal of the second filter, a third terminal to be connected to an input terminal of the third filter, a fourth terminal to be connected to a first antenna connection terminal, and a fifth terminal to be connected to a second antenna connection terminal. The high-frequency module has a first mode to simultaneously transmit a reception signal in the first band being passed through the first filter without being passed through the second filter and a reception signal in the second band being passed through the third filter, a second mode to transmit a reception signal in the first band being passed through the first filter without being passed through the second filter alone, and a third mode to simultaneously transmit a reception signal in the first band being passed through the first filter and a reception signal in the first band being passed through the second filter. A distance between the input terminal of the first filter and the first terminal is shorter than a distance between the input terminal of the second filter and the second terminal.

Meanwhile, a high-frequency module according to another aspect of the present disclosure includes: a module substrate; a first filter and a second filter disposed at the module substrate and having a passband including a reception band of a first band; a third filter disposed at the module substrate and having a passband including a reception band of a second band; and a switch disposed at the module substrate and including a first terminal to be connected to an input terminal of the first filter, a second terminal to be connected to an input terminal of the second filter, a third terminal to be connected to an input terminal of the third filter, a fourth terminal to be connected to a first antenna connection terminal, and a fifth terminal to be connected to a second antenna connection terminal. The high-frequency module has a first mode to simultaneously receive a signal in the first band and a signal in the second band while connecting the first terminal to the fourth terminal or the fifth terminal, connecting the third terminal to the fourth terminal or the fifth terminal, and not connecting the second terminal to the fourth terminal or the fifth terminal, a second mode to receive a signal in the first band while connecting the first terminal to the fourth terminal or the fifth terminal, not connecting the second terminal to the fourth terminal or the fifth terminal, and not connecting the third terminal to the fourth terminal or the fifth terminal, and a third mode to simultaneously receive a signal in the first band and a signal in the first band while connecting the first terminal to the fourth terminal or the fifth terminal, connecting the second terminal to the fourth terminal or the fifth terminal, and not connecting the third terminal to the fourth terminal or the fifth terminal. A distance between the input terminal of the first filter and the first terminal is shorter than a distance between the input terminal of the second filter and the second terminal.

### Advantageous Effects

According to a high-frequency module of an aspect of the present disclosure, deterioration in reception sensitivity may be suppressed.

### BRIEF DESCRIPTION OF DRAWINGS

FIG. 1 is a circuit configuration diagram of a high-frequency module and a communication device according to an embodiment.

FIG. 2A is a diagram showing a state of connection and flows of high-frequency signals in a first mode of the high-frequency module according to the embodiment.

FIG. 2B is a diagram showing a state of connection and a flow of a high-frequency signal in a second mode of the high-frequency module according to the embodiment.

FIG. 2C is a diagram showing a state of connection and flows of high-frequency signals in a third mode of the high-frequency module according to the embodiment.

FIG. 3A is a plan view of a high-frequency module according to Example 1.

FIG. 3B is another plan view of the high-frequency module according to the Example 1.

FIG. 3C is a cross-sectional view of the high-frequency module according to the Example 1.

FIG. 4A is a plan view of a high-frequency module according to Example 2.

FIG. 4B is another plan view of the high-frequency module according to the Example 2.

FIG. 4C is a cross-sectional view of the high-frequency module according to the Example 2.

FIG. 5A is a plan view of a high-frequency module according to Example 3.

FIG. 5B is a cross-sectional view of the high-frequency module according to the Example 3.

### DESCRIPTION OF EMBODIMENTS

An embodiment of the present disclosure will be described below in detail by using the drawings. Each embodiment described below represents a comprehensive or specific example. Numerical values, shapes, materials, constituents, layouts and states of connection of the constituents, and the like shown in the following embodiment are mere examples and are not intended to limit the present disclosure.

Here, the respective drawings are schematic drawings subjected to emphasis, omission, or ratio adjustment as appropriate in order to demonstrate the present disclosure. The drawings are not always precisely illustrated and may be different from shapes, positional relations, or ratios in reality in some cases. In the respective drawings, substantially the same structures are denoted by the same reference signs and overlapping explanations thereof may be omitted or simplified in some cases.

In the following respective drawings, x axis and y axis are axes that are orthogonal to each other on a plane that is parallel to main surfaces of a module substrate. To be more precise, in a case where the module substrate has a rectangular shape in plan view, the x axis is parallel to a first side of the module substrate, and the y axis is parallel to a second side being orthogonal to the first side of the module substrate. Meanwhile, z axis is an axis that is perpendicular to the main surfaces of the module substrate, and a positive direction thereof represents an upward direction and a negative direction thereof represents a downward direction.

In a circuit configuration of the present disclosure, a state of being “connected” includes not only a case of being directly electrically connected with a connection terminal and/or a wiring conductor but also a case of being indirectly electrically connected in which one or more circuit element are interposed therebetween. A state of being “connected between A and B” means a state of being located between A and B and connected to both A and B.

In terms of a component layout of the present disclosure, a state in which a “component is disposed at a substrate” includes a state in which the component is disposed on a main surface of the substrate and a state in which the component is disposed in the substrate. The state in which the “component is disposed on the main surface of the substrate” includes a state in which the component is disposed in contact with the main surface of the substrate, and in addition thereto, a state in which the component is disposed above the main surface without being in contact with the main surface (such as a state in which the component is stacked on another component that is disposed in contact with the main surface). Meanwhile, the state in which the “component is disposed on the main surface of the substrate” may include a state in which the component is disposed in a recess formed in the main surface. In addition to a state in which the component is encapsulated in the module substrate, the state in which the “component is disposed in the substrate” includes a state in which the entire component is disposed between the two main surfaces of the substrate even though part of the component is not covered with the substrate, and a state in which only part of the component is disposed in the substrate.

Meanwhile, in the present disclosure, a state in which a “component (element) A is disposed in series to a path B” means a state in which both a signal input end and a signal output end of the component (element) A are connected to wiring, electrodes, or terminals constituting the path B.

In the meantime, in terms of the component layout of the present disclosure, a “plan view of the module substrate” means a view while orthographically projecting an object from a positive side on the z axis toward the xy plane. A state in which “A overlaps B in plan view” means a state in which at least part of a region of A orthographically projected onto the xy plane overlaps at least part of a region of B orthographically projected onto the xy plane. Meanwhile, a state in which “A is disposed between B and C” means a state in which A passes through at least one of line segments that connect any points in B to any points in C.

Meanwhile, in terms of the component layout of the present disclosure, a state in which “A is disposed adjacent to B” represents a state in which A and B are disposed close to each other. To be more precise, this state means that no other circuit components are present in a space where A faces B. In other words, the state in which “A is disposed adjacent to B” means that each of line segments reaching from any points on the surface of A facing B to B in a direction normal to the relevant surface does not pass through circuit components other than A and B. Here, the circuit component means a component that includes an active element and/or a passive element. That is to say, active components inclusive of a transistor, a diode, or the like, and passive components inclusive of an inductor, a transformer, a capacitor, a resistor, or the like are included in the circuit component, and an electromechanical component inclusive of a terminal, a connector, wiring, or the like is not included therein.

In the present disclosure, a term “terminal” means a point where a conductor in an element is terminated. Here, when impedance of a conductor between elements is sufficiently low, the terminal is interpreted not only as a single point but also as any point on the conductor between the elements or as the entire conductor.

Meanwhile, terms that indicate relations between elements as typified by “parallel”, “perpendicular”, and so forth, terms that indicate shapes of an element as typified by a “rectangle”, and numerical ranges do not only represent strict meanings thereof but also represent substantially equivalent ranges such as inclusion of errors in several percent.

An expression “a passband of a filter” is a portion of a frequency spectrum to be transmitted by a filter, which is defined as a frequency band in which output power is not attenuated by 3 dB or more from the maximum output power. Accordingly, a high range end and a low range end of a passband of a band pass filter are specified as a higher frequency and a lower frequency at two points where the output power is reduced by 3 dB from the maximum output power.

A “reception band” means a frequency band used for reception by the communication device. For example, frequency bands that are different from each other are used as a transmission band and as a reception band in frequency division duplex (FDD), and the same frequency band is used as the transmission band and as the reception band in time division duplex (TDD). Particularly, in the FDD, an uplink operation band is used as the transmission band and a downlink operation band is used as reception band in a case where the communication device is mounted on user equipment (UE) of a cellular network. On the other hand, the downlink operation band is used as the transmission band and the uplink operation band is used as reception band in a case where the communication device is mounted as a base station (BS) of the cellular network.

### Embodiment

### [1 Circuit Configuration of Communication Device 5]

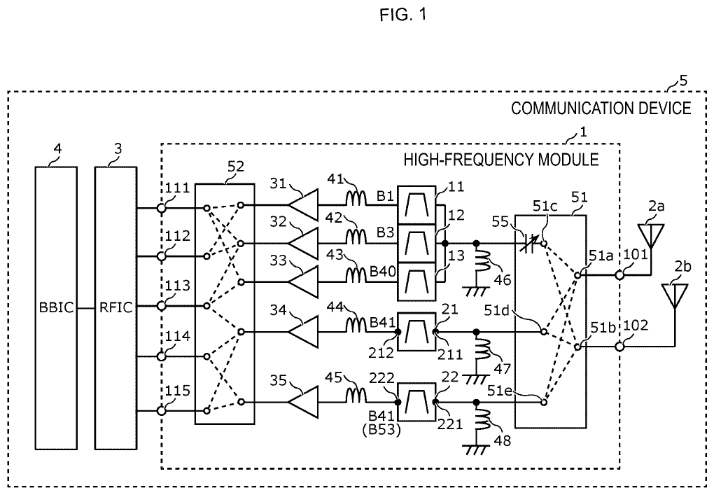

First, a circuit configuration of a communication device 5 according to the present embodiment will be described with reference to FIG. 1. FIG. 1 is a circuit configuration diagram of the communication device 5 according to the present embodiment. In FIG. 1, a number affixed to B which is described beside a filter represents a number to specify a frequency band of LTE and/or 5GNR. For example, code “B1” represents Band 1 for LTE and n1 for 5GNR. Here, the frequency bands indicated in FIG. 1 show examples for facilitating the understanding of a person skilled in the art, and the frequency bands corresponding to the respective filters are not limited to the description in FIG. 1.

Note that FIG. 1 shows exemplary circuit configurations of the communication device 5 and a high-frequency module 1. The communication device 5 and the high-frequency module 1 can be mounted by using any of various and versatile circuiting mounting modes and circuit techniques. Accordingly, the description of the communication device 5 and the high-frequency module 1 provided below is not supposed to be interpreted in a limited fashion.

The communication device 5 is mounted on UE of a cellular network, which is typically any of a cellular phone, a smartphone, a tablet computer, a wearable device, and the like. Here, the communication device 5 may be any of an Internet of things (IoT) sensor device, a medical/healthcare device, a vehicle, an unmanned aerial vehicle (UAV) (or so-called a drone), and an automated guided vehicle (AGV). Alternatively, the communication device 5 may be mounted on a BS of a cellular communication system.

As shown in FIG. 1, the communication device 5 includes the high-frequency module 1, antennas 2a and 2b, a radio frequency integrated circuit (RFIC) 3, and a baseband integrated circuit (BBIC) 4.

The high-frequency module 1 can transmit a high-frequency signal between the antennas 2a and 2b, and the RFIC 3. An internal configuration of the high-frequency module 1 will be described later.

The antennas 2a and 2b are connected to antenna connection terminals 101 and 102 of the high-frequency module 1, respectively. The antennas 2a and 2b can receive the high-frequency signal from outside of the communication device 5 and supply the high-frequency signal to the high-frequency module 1. Moreover, the antennas 2a and 2b may transmit the high-frequency signal supplied from the high-frequency module 1 to the outside of the communication device 5. Here, the antenna 2a and/or the antenna 2b need not be included in the communication device 5. Alternatively, the communication device 5 may further include one or more antennas in addition to the antennas 2a and 2b.

The RFIC 3 is an example of a signal processing circuit that processes the high-frequency signal. To be more precise, the RFIC 3 can subject the high-frequency reception signal received via a receive path of the high-frequency module 1 to signal processing by downconversion and the like, and output a reception signal generated by the signal processing to the BBIC 4. Moreover, the RFIC 3 may subject a transmission signal received from the BBIC 4 to signal processing by upconversion and the like, and output a high-frequency transmission signal generated by the signal processing to the high-frequency module 1. Meanwhile, the RFIC 3 may include a control unit for controlling a switch, power amplifiers, and the like provided to the high-frequency module 1. Here, part or all of the control unit may be provided to the outside of the RFIC 3, or may be included in, for example, the BBIC 4 or the high-frequency module 1.

The BBIC 4 is the baseband signal processing circuit that performs signal processing by using a frequency band having a lower frequency than that of the high-frequency signal transmitted by the high-frequency module 1. For example, an image signal for image display, and/or a voice signal for a voice call via a speaker are used as the signals to be processed by the BBIC 4. Note that the BBIC 4 need not be included in the communication device 5.

### [2 Circuit Configuration of High-Frequency Module 1]

Next, the circuit configuration of the high-frequency module 1 according to the present embodiment will be described with reference to FIG. 1. The high-frequency module 1 includes the antenna connection terminals 101 and 102, low-noise amplifiers 31, 32, 33, 34, and 35, filters 11, 12, 13, 21, and 22, inductors 41, 42, 43, 44, 45, 46, 47, and 48, switches 51 and 52, and high-frequency output terminals 111, 112, 113, 114, and 115.

The antenna connection terminals 101 and 102 are external connection terminals of the high-frequency module 1. The antenna connection terminal 101 is an example of a first antenna connection terminal which is connected to the antenna 2a and the switch 51. The antenna connection terminal 102 is an example of a second antenna connection terminal which is connected to the antenna 2b and the switch 51. Accordingly, the high-frequency module 1 can receive the reception signals from the antennas 2a and 2b with the antenna connection terminals 101 and 102 interposed therebetween.

The low-noise amplifier 34 is an example of a first low-noise amplifier which is connected between the filter 21 and the switch 52. To be more precise, an input end of the low-noise amplifier 34 is connected to an output end of the filter 21 with the inductor 44 interposed therebetween, and an output end of the low-noise amplifier 34 is connected to the switch 52. The low-noise amplifier 34 can amplify a reception signal in a first band received with the filter 21 interposed therebetween. Here, the low-noise amplifier 34 need not be included in the high-frequency module 1. For example, the low-noise amplifier 34 may be connected between the high-frequency module 1 and the RFIC 3, or may be included in the RFIC 3.

The low-noise amplifier 35 is an example of a second low-noise amplifier which is connected between the filter 22 and the switch 52. To be more precise, an input end of the low-noise amplifier 35 is connected to an output end of the filter 22 with the inductor 45 interposed therebetween, and an output end of the low-noise amplifier 35 is connected to the switch 52. The low-noise amplifier 35 can amplify reception signals in the first band and a third band received with the filter 22 interposed therebetween. Here, the low-noise amplifier 35 does not have to be capable of amplifying the reception signal in the third band. Meanwhile, the low-noise amplifier 35 need not be included in the high-frequency module 1. For example, the low-noise amplifier 35 may be connected between the high-frequency module 1 and the RFIC 3, or may be included in the RFIC 3.

The low-noise amplifier 31 is an example of a third low-noise amplifier which is connected between the filter 11 and the switch 52. To be more precise, an input end of the low-noise amplifier 31 is connected to an output end of the filter 11 with the inductor 41 interposed therebetween, and an output end of the low-noise amplifier 31 is connected to the switch 52. The low-noise amplifier 31 can amplify a reception signal in a second band received with the filter 11 interposed therebetween. Here, the low-noise amplifier 31 need not be included in the high-frequency module 1. For example, the low-noise amplifier 31 may be connected between the high-frequency module 1 and the RFIC 3, or may be included in the RFIC 3.

The low-noise amplifier 32 is another example of the third low-noise amplifier which is connected between the filter 12 and the switch 52. To be more precise, an input end of the low-noise amplifier 32 is connected to an output end of the filter 12 with the inductor 42 interposed therebetween, and an output end of the low-noise amplifier 32 is connected to the switch 52. The low-noise amplifier 32 can amplify the reception signal in the second band received with the filter 12 interposed therebetween. Here, the low-noise amplifier 32 need not be included in the high-frequency module 1. For example, the low-noise amplifier 32 may be connected between the high-frequency module 1 and the RFIC 3, or may be included in the RFIC 3.

The low-noise amplifier 33 is another example of the third low-noise amplifier which is connected between the filter 13 and the switch 52. To be more precise, an input end of the low-noise amplifier 33 is connected to an output end of the filter 13 with the inductor 43 interposed therebetween, and an output end of the low-noise amplifier 33 is connected to the switch 52. The low-noise amplifier 33 can amplify the reception signal in the second band received with the filter 13 interposed therebetween. Here, the low-noise amplifier 33 need not be included in the high-frequency module 1. For example, the low-noise amplifier 33 may be connected between the high-frequency module 1 and the RFIC 3, or may be included in the RFIC 3.

Each of the low-noise amplifiers 31 to 35 can be formed from a field effect transistor (FET), and can be manufactured by using a semiconductor material. For example, silicon single crystal, gallium nitride (GaN), or silicon carbide (SiC) can be used as the semiconductor material. Here, amplification transistors of the low-noise amplifiers 31 to 35 are not limited to the FETs. For example, some or all of the low-noise amplifiers 31 to 35 may be formed from bipolar transistors.

The filter 21 is an example of a first filter, which is a filter having a passband including the reception band of the first band. The filter 21 is connected between the switch 51 and the low-noise amplifier 34. To be more precise, an input terminal 211 of the filter 21 is connected to a terminal 51d of the switch 51, and an output terminal 212 of the filter 21 is connected to the input end of the low-noise amplifier 34 with the inductor 44 interposed therebetween.

The filter 22 is an example of a second filter, which is a filter having a passband including the reception bands of the first band and the third band. The filter 22 is connected between the switch 51 and the low-noise amplifier 35. To be more precise, an input terminal 221 of the filter 22 is connected to a terminal 51e of the switch 51, and an output terminal 222 of the filter 22 is connected to the input end of the low-noise amplifier 35 with the inductor 45 interposed therebetween. The third band at least partially overlaps the first band. Here, the filter 22 does not have to include the reception band of the third band in the passband, and may be a filter that has the passband including the reception band of the first band.

The filter 11 is an example of a third filter, which is a filter having a passband including the reception band of the second band. The filter 11 is connected between the switch 51 and the low-noise amplifier 31. To be more precise, an input terminal of the filter 11 is connected to a terminal 51c of the switch 51, and an output terminal of the filter 11 is connected to the input end of the low-noise amplifier 31 with the inductor 41 interposed therebetween.

The filter 12 is another example of the third filter, which is the filter having the passband including the reception band of the second band. The filter 12 is connected between the switch 51 and the low-noise amplifier 32. To be more precise, an input terminal of the filter 12 is connected to the terminal 51c of the switch 51, and an output terminal of the filter 12 is connected to the input end of the low-noise amplifier 32 with the inductor 42 interposed therebetween.

The filter 13 is another example of the third filter, which is the filter having the passband including the reception band of the second band. The filter 13 is connected between the switch 51 and the low-noise amplifier 33. To be more precise, an input terminal of the filter 13 is connected to the terminal 51c of the switch 51, and an output terminal of the filter 13 is connected to the input end of the low-noise amplifier 33 with the inductor 43 interposed therebetween.

Here, one or two out of the filters 11 to 13 need not be included in the high-frequency module 1. That is to say, at least one of the filters 11 to 13 has to be included in the high-frequency module 1.

Meanwhile, the terminal 51d to which the input terminal 211 of the filter 21 is connected is a different terminal from the terminal 51e to which the input terminal 221 of the filter 22 is connected. These terminals are not provided as one terminal in common.

In the meantime, the respective input terminals of the filters 11 to 13 do not have to be connected to the single terminal 51c, and may instead be connected to different terminals of the switch 51.

Surface acoustic wave (SAW) filters, bulk acoustic wave (BAW) filters, LC resonance filters, dielectric resonance filters, or any combinations of these filters may be used for the filters 11 to 13 as well as 21 and 22. Moreover, the filters are not limited thereto.

The switch 51 is connected between the set of the antenna connection terminals 101 and 102 and the set of the filters 11 to 13 as well as 21 and 22. To be more precise, the switch 51 includes terminals 51a, 51b, 51c, 51d, and 51e. The terminal 51a is an example of a fourth terminal, which is connected to the antenna connection terminal 101. The terminal 51b is an example of a fifth terminal, which is connected to the antenna connection terminal 102. The terminal 51c is the example of a third terminal, which is connected to the input terminals of the filters 11 to 13. The terminal 51d is the example of a first terminal, which is connected to the input terminal 211 of the filter 21. The terminal 51e is the example of a second terminal, which is connected to the input terminal 221 of the filter 22.

Here, the switch 51 may include a digital tunable capacitor (DTC) 55 connected between the terminal 51c and the input terminals of the filters 11 to 13. The DTC 55 has a structure in which multiple capacitors and multiple switches are connected to a common terminal. Connection between each of the multiple capacitors and the common terminal is switched between a connected state and a disconnected state by using each of the multiple switches. Accordingly, a capacitance value of the DTC 55 is variable in a stepwise manner so as to correspond to switching of the connection of the multiple switches. Here, switching of the capacitance value of the DTC 55 is executed by a control unit of the RFIC 3. The control unit may switch the capacitance value of the DTC 55 depending on which one of a first mode, a second mode, and a third mode to be described later is supposed to be executed by the high-frequency module 1.

In the above-described configuration, the switch 51 can connect the terminals 51a and 51b to the terminals 51c to 51e based on a control signal from the RFIC 3, for example. That is to say, the switch 51 can switch between a state of connecting only one of the terminals 51a and 51b to any one of the terminals 51c to 51e, and, a state of connecting the terminals 51a and 51b to any two out of the terminals 51c to 51e, respectively. The switch 51 is formed from a multi-connection type switch circuit, for example.

The switch 52 is connected between the set of the low-noise amplifiers 31 to 35 and the set of the high-frequency output terminals 111 to 115. The switch 52 includes first to fifth input terminals and first to fifth output terminals. The first input terminal is connected to the output end of the low-noise amplifier 31. The second input terminal is connected to the output end of the low-noise amplifier 32. The third input terminal is connected to the output end of the low-noise amplifier 33. The fourth input terminal is connected to the output end of the low-noise amplifier 34. The fifth input terminal is connected to the output end of the low-noise amplifier 35. The first output terminal is connected to the high-frequency output terminal 111. The second output terminal is connected to the high-frequency output terminal 112. The third output terminal is connected to the high-frequency output terminal 113. The fourth output terminal is connected to the high-frequency output terminal 114. The fifth output terminal is connected to the high-frequency output terminal 115.

In the above-described configuration, the switch 52 can connect the first to fifth input terminals to the first to fifth output terminals based on the control signal from the RFIC 3, for example. The switch 52 is formed from a multi-connection type switch circuit, for example.

The high-frequency output terminals 111 to 115 are external connection terminals of the high-frequency module 1. The high-frequency output terminals 111 to 115 are connected to the RFIC 3. Accordingly, the high-frequency module 1 can supply the reception signal to the RFIC 3 with the high-frequency output terminals 111 to 115 interposed therebetween.

The inductor 47 is an example of a first inductor, which is connected between the ground and a path that connects the input terminal 211 of the filter 21 to the terminal 51d. The inductor 47 performs impedance matching between the switch 51 and the filter 21. Here, the inductor 47 may be absent.

The inductor 48 is an example of a second inductor, which is connected between the ground and a path that connects the input terminal 221 of the filter 22 to the terminal 51e. The inductor 48 performs impedance matching between the switch 51 and the filter 22. Here, the inductor 48 may be absent.

Note that an inductance value of the inductor 47 is preferably smaller than an inductance value of the inductor 48. According to this configuration, the impedance matching between the filter 21 and the switch 51 to be used in the first mode, the second mode, and the third mode, and the impedance matching between the filter 22 and the switch 51 to be used only in the third mode, may respectively be optimized.

The inductor 46 is connected between the ground and a path that connects the input terminals of the filters 11 to 13 to the terminal 51c. The inductor 46 performs impedance matching between the filters 11 to 13 and the switch 51. The inductor 46 may be disposed in series to the path that connects the filters 11 to 13 to the switch 51. Alternatively, the inductor 46 may be absent.

The inductor 41 is disposed in series to a path that connects the output terminal of the filter 11 to the input end of the low-noise amplifier 31, and performs impedance matching between the filter 11 and the low-noise amplifier 31. Here, the inductor 41 may be absent. The inductor 42 is disposed in series to a path that connects the output terminal of the filter 12 to the input end of the low-noise amplifier 32, and performs impedance matching between the filter 12 and the low-noise amplifier 32. Here, the inductor 42 may be absent. The inductor 43 is disposed in series to a path that connects the output terminal of the filter 13 to the input end of the low-noise amplifier 33, and performs impedance matching between the filter 13 and the low-noise amplifier 33. Here, the inductor 43 may be absent. The inductor 44 is disposed in series to a path that connects an output terminal of the filter 21 to the input end of the low-noise amplifier 34, and performs impedance matching between the filter 21 and the low-noise amplifier 34. Here, the inductor 44 may be absent. The inductor 45 is disposed in series to a path that connects an output terminal of the filter 22 to the input end of the low-noise amplifier 35, and performs impedance matching between the filter 22 and the low-noise amplifier 35. Here, the inductor 45 may be absent.

The first band to third band are frequency bands for a communication system to be constructed by using the radio access technology (RAT), which are defined in advance by standardizing bodies (for example, 3GPP (a registered trademark), IEEE, and the like). As examples of the communication system, it is possible to cite a 5th Generation New Radio (5GNR) system, a Long Term Evolution (LTE) system, a Wireless Local Area Network (WLAN) system, and the like.

The first band is any of Band 41, Band 77, and Band 78 for LTE as well as n41, n77, and n78 for 5GNR, for example.

The second band is any of Band 1, Band 3, and Band 40 for LTE as well as n1, n3, and n40 for 5GNR, for example.

The third band is Band 53 for LTE or n53 for 5GNR, for example.

Note that band combinations allowing simultaneous reception of signals are defined in advance by the standardizing bodies and the like. A band combination allowing simultaneous reception of signals is defined as a band combinations for CA, EN-DC, New Radio-Dual Connectivity (NR-DC), or New Radio E-UTRAN-Dual Connectivity (NE-DC), for example.

### [3 Communication Modes]

Next, the communication modes provided to the high-frequency module 1 according to the present embodiment will be described.

### [3.1 First Mode]

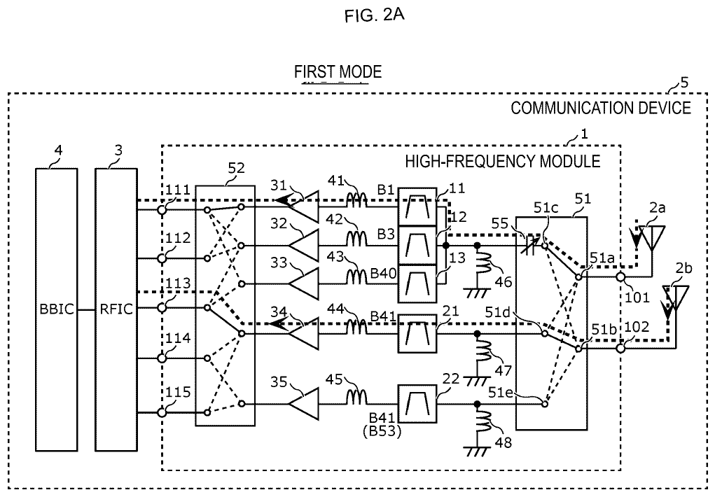

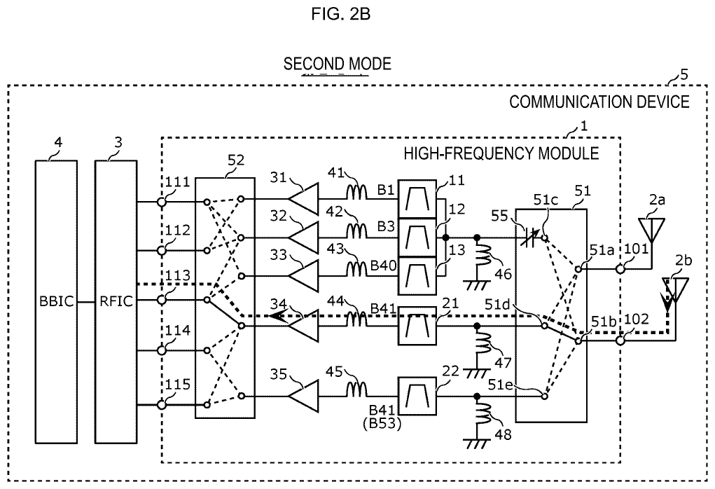

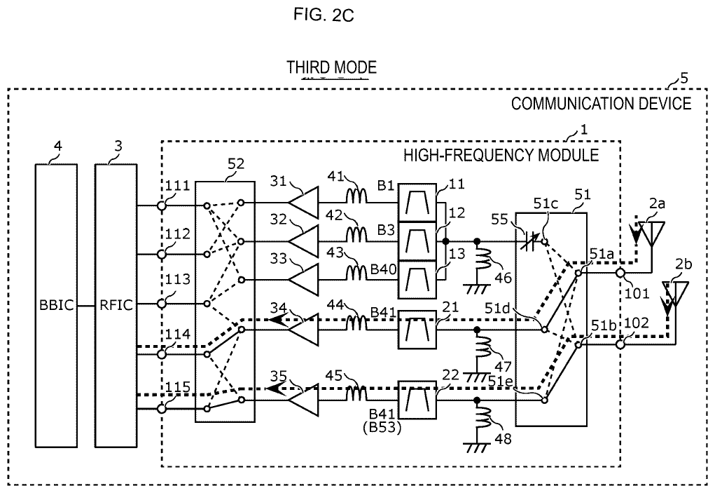

The first mode will be described with reference to FIG. 2A to begin with. FIG. 2A is a diagram showing a state of connection and flows of high-frequency signals in the first mode of the high-frequency module 1 according to the present embodiment. In FIG. 2A, arrows in dashed lines represent flows of reception signals.

The first mode is a communication mode for simultaneously receiving signals in the first band (e.g., B41) and the second band (e.g., B1), which is a communication mode for CA or DC, for example. As shown in FIG. 2A, the switch 51 connects the terminal 51d to the terminal 51b, connects the terminal 51c to the terminal 51a, and does not connect the terminal 51e to the terminal 51a or the terminal 51b. Accordingly, the filters 11 to 13 are connected to the antenna connection terminal 101 and the filter 21 is connected to the antenna connection terminal 102.

As a result, the reception signal in the first band is transmitted from the antenna 2b to the RFIC 3 while being passed through the antenna connection terminal 102, the switch 51, the filter 21, the low-noise amplifier 34, the switch 52, and the high-frequency output terminal 113. The reception signal in the second band is transmitted from the antenna 2a to the RFIC 3 while being passed through the antenna connection terminal 101, switch 51, the filter 11, the low-noise amplifier 31, the switch 52, and the high-frequency output terminal 111.

That is to say, the first mode is the communication mode that can simultaneously transmit the reception signal in the first band being passed through the filter 21 without being passed through the filter 22, and the reception signal in the second band being passed through the filter 11.

Here, in the first mode, the switch 51 may connect the terminal 51d to the terminal 51a and connect the terminal 51c to the terminal 51b. In this case, the filters 11 to 13 are connected to the antenna connection terminal 102 and the filter 21 is connected to the antenna connection terminal 101.

Meanwhile, in the first mode, the switch 51 may connect the terminal 51d to the terminal 51a and connect the terminal 51c to the terminal 51a. In this case, the filters 11 to 13 are connected to the antenna connection terminal 101 and the filter 21 is connected to the antenna connection terminal 101. Alternatively, in the first mode, the switch 51 may connect the terminal 51d to the terminal 51b and connect the terminal 51c to the terminal 51b. In this case, the filters 11 to 13 are connected to the antenna connection terminal 102 and the filter 21 is connected to the antenna connection terminal 102.

Here, in FIG. 2A, any of the signals of Band 3 and Band 40 for LTE and the signals of n3 and n40 for 5GNR may be received instead of the signal of Band 1 for LTE or the signal of n1 for 5GNR.

Meanwhile, in the first mode, a signal in the first band and two or more signals in the second band may be received simultaneously. For example, the signal of Band 41 (the first band) for LTE, the signal of Band 1 (the second band) for LTE, and the signal of Band 3 (the second band) for LTE may be received simultaneously.

### [3.2 Second Mode]

Next, the second mode will be described with reference to FIG. 2B. FIG. 2B is a diagram showing a state of connection and a flow of a high-frequency signal in the second mode of the high-frequency module 1 according to the present embodiment. In FIG. 2B, arrows in dashed lines represent a flow of a reception signal.

The second mode is a communication mode for receiving a signal in the first band (e.g., B41) alone. As shown in FIG. 2B, the switch 51 connects the terminal 51d to the terminal 51b, does not connect the terminal 51e to the terminal 51a or 51b, and does not connect the terminal 51c to the terminal 51a or 51b. Accordingly, the filter 21 is connected to the antenna connection terminal 102.

As a result, the reception signal in the first band is transmitted from the antenna 2b to the RFIC 3 while being passed through the antenna connection terminal 102, the switch 51, the filter 21, the low-noise amplifier 34, the switch 52, and the high-frequency output terminal 113.

That is to say, the second mode is the communication mode that can transmit the reception signal in the first band alone, which is passed through the filter 21 without being passed through the filter 22.

Here, in the second mode, the switch 51 may connect the terminal 51d to the terminal 51a without connecting the terminal 51d to the terminal 51b.

### [3.3 Third Mode]

Next, the third mode will be described with reference to FIG. 2C. FIG. 2C is a diagram showing a state of connection and flows of high-frequency signals in the third mode of the high-frequency module 1 according to the present embodiment. In FIG. 2C, arrows in dashed lines represent flows of reception signals.

The third mode is a communication mode for simultaneously receiving a signal in the first band (e.g., B41) and another signal in the first band (e.g., B41), which is a communication mode for MIMO, for example. As shown in FIG. 2C, the switch 51 connects the terminal 51d to the terminal 51a, connects the terminal 51e to the terminal 51b, and does not connect the terminal 51c to the terminal 51a or the terminal 51b. Accordingly, the filter 21 is connected to the antenna connection terminal 101 and the filter 22 is connected to the antenna connection terminal 102.

As a result, one of the reception signals in the first band is transmitted from the antenna 2a to the RFIC 3 while being passed through the antenna connection terminal 101, the switch 51, the filter 21, the low-noise amplifier 34, the switch 52, and the high-frequency output terminal 114. Meanwhile, another one of the reception signals in the first band is transmitted from the antenna 2b to the RFIC 3 while being passed through the antenna connection terminal 102, switch 51, the filter 22, the low-noise amplifier 35, the switch 52, and the high-frequency output terminal 115.

That is to say, the third mode is the communication mode that can simultaneously transmit the reception signal in the first band being passed through the filter 21, and the reception signal in the first band being passed through the filter 22.

Here, in the third mode, the switch 51 may connect the terminal 51d to the terminal 51b, and connect the terminal 51e to the terminal 51a. In this case, the filter 21 is connected to the antenna connection terminal 102 and the filter 22 is connected to the antenna connection terminal 101.

Note that in addition to the above-described first to third modes, the high-frequency module 1 may include a fourth mode to be described below. The fourth mode is a communication mode for simultaneously receiving two signals in the first band (e.g., B41) and a signal in the second band (B1), which is a communication mode for CA or DC, and for MIMO, for example. In this case, the switch 51 connects the terminal 51c to the terminal 51a, connects the terminal 51d to the terminal 51a, and connects the terminal 51e to the terminal 51b. Accordingly, the filters 11 to 13 and 21 are connected to the antenna connection terminal 101 and the filter 22 is connected to the antenna connection terminal 102.

As a result, one of the reception signals in the first band is transmitted from the antenna 2a to the RFIC 3 while being passed through the antenna connection terminal 101, the switch 51, the filter 21, the low-noise amplifier 34, and the switch 52. Meanwhile, another one of the reception signals in the first band is transmitted from the antenna 2b to the RFIC 3 while being passed through the antenna connection terminal 102, the switch 51, the filter 22, the low-noise amplifier 35, and the switch 52. In the meantime, the reception signal in the second band is transmitted from the antenna 2a to the RFIC 3 while being passed through the antenna connection terminal 101, the switch 51, the filter 11, the low-noise amplifier 31, and the switch 52.

That is to say, the fourth mode is the communication mode that can simultaneously transmit the reception signal in the first band being passed through the filter 21, the reception signal in the first band being passed through the filter 22, and the reception signal in the second band being passed through the filter 11.

Here, in the fourth mode, the terminal 51c may be connected to the terminal 51b, the terminal 51d may be connected to the terminal 51b, and the terminal 51e may be connected to the terminal 51a. Accordingly, the filters 11 to 13 and 21 are connected to the antenna connection terminal 102 and the filter 22 is connected to the antenna connection terminal 101.

Meanwhile, in the fourth mode, two signals in the first band and two or more signals in the second band may be received simultaneously. For example, two signals of Band 41 (the first band) for LTE, a signal of Band 1 (the second band) for LTE, and a signal of Band 3 (the second band) for LTE may be received simultaneously.

### [4 Mounting Example of High-Frequency Module 1A According to Example 1]

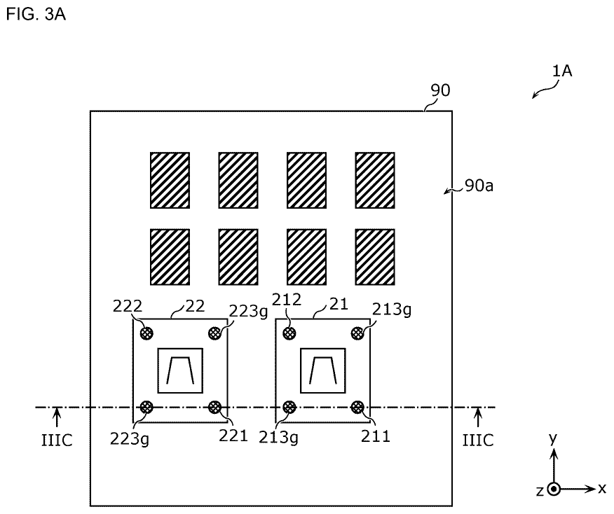

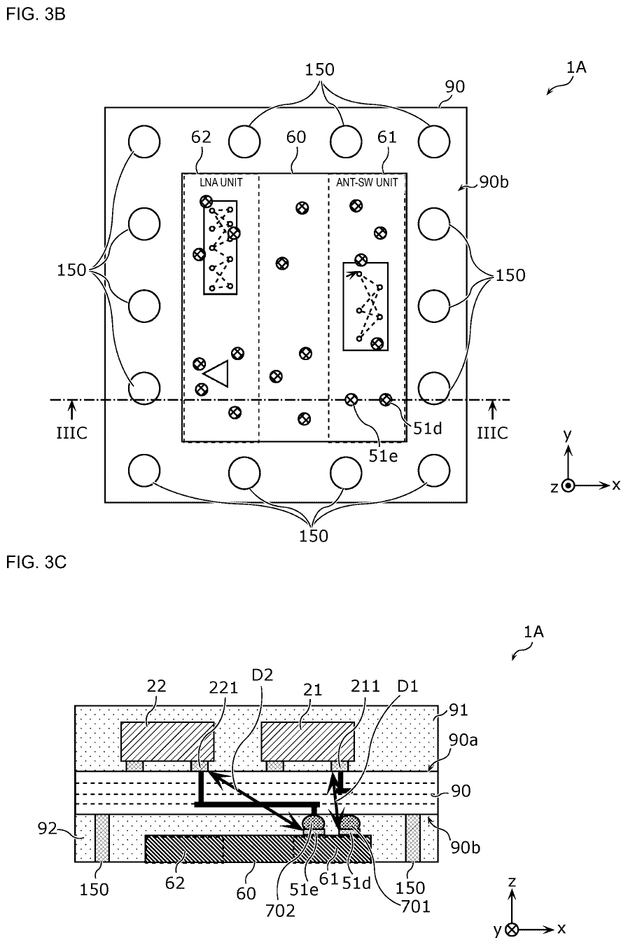

Next, as a mounting example of the high-frequency module 1 configured as described above, a high-frequency module 1A according to Example 1 will be described with reference to FIGS. 3A to 3C.

FIGS. 3A and 3B are plan views of the high-frequency module 1A according to the Example 1. FIG. 3C is a cross-sectional view of the high-frequency module 1A according to the Example 1. FIG. 3A is a view showing a main surface 90a side of a module substrate 90 from a positive side on the z axis. FIG. 3B is a view transparently seeing a main surface 90b side of the module substrate 90 from the positive side on the z axis. FIG. 3C shows a cross-section taken along IIIC-IIIC line in FIGS. 3A and 3B.

Note that FIGS. 3A to 3C omit illustration of part of wiring that connects multiple circuit components disposed at the module substrate 90. Moreover, FIGS. 3A to 3C omit illustration of a shield electrode layer that covers surfaces of resin members 91 and 92. Note that the resin members 91 and 92 and the shield electrode layer may be absent. Meanwhile, in FIG. 3A, each hatched block represents any circuit component that is not essential to the present disclosure.

As shown in FIGS. 3A to 3C, the high-frequency module 1A includes the module substrate 90, the filters 21 and 22, an integrated circuit 60, multiple external connection terminals 150, and the resin members 91 and 92.

The module substrate 90 has the main surfaces 90a (a first main surface) and 90b (a second main surface) opposed to each other. A ground plane and the like are formed in the module substrate 90 and on the main surface 90a and the main surface 90b. Although the module substrate 90 has a rectangular shape in plan view in FIGS. 3A and 3B, the shape of the module substrate 90 is not limited thereto.

For example, a low temperature co-fired ceramic (LTCC) substrate or a high temperature co-fired ceramic (HTCC) substrate having a laminated structure of multiple dielectric layers, a component-embedded board, a substrate including a redistribution layer (RDL), a printed circuit board, or the like can be used as the module substrate 90. However, the module substrate 90 is not limited to these substrates.

The resin member 91 is disposed on the main surface 90a and covers the main surface 90a and some of the multiple circuit components, thus having a function to secure reliability such as mechanical strength and moisture resistance of the aforementioned multiple circuit components. The resin member 92 is disposed on the main surface 90b and covers the main surface 90b and some of the multiple circuit components, thus having a function to secure reliability such as mechanical strength and moisture resistance of the aforementioned multiple circuit components.

The filters 21 and 22 are disposed on the main surface 90a. As shown in FIG. 3A, the filter 21 includes the input terminal 211, the output terminal 212, and a ground terminal 213g. The filter 22 includes the input terminal 221, the output terminal 222, and a ground terminal 223g. Each of the input terminal 211, the output terminal 212, and the ground terminal 213g is either a planar electrode or a bump electrode disposed on a surface of the filter 21. Each of the input terminal 221, the output terminal 222, and the ground terminal 223g is either a planar electrode or a bump electrode disposed on a surface of the filter 22.

Although not illustrated, the filters 11 to 13 and the inductors 41 to 48 are disposed on the main surface 90a. Here, the filters 11 to 13 and the inductors 41 to 48 may be disposed on the main surface 90b instead.

The integrated circuit 60 is an example of a second integrated circuit, which is disposed on the main surface 90b. As shown in FIG. 3B, the integrated circuit 60 includes an antenna SW unit 61 and an LNA unit 62. The antenna SW unit 61 includes the switch 51, and is formed in a region on the right side (in the positive direction on the x axis) of the integrated circuit 60. The LNA unit 62 includes the low-noise amplifiers 31 to 35 and the switch 52, and is formed in a region on the left side (in the negative direction on the x axis) of the integrated circuit 60. Here, although the integrated circuit 60 has a rectangular shape in plan view of the module substrate 90 in FIG. 3B, the shape of the integrated circuit 60 is not limited thereto.

As shown in FIG. 3B, each of the terminals 51d and 51e of the switch 51 is an external connection terminal disposed on a surface of the integrated circuit 60. To be more precise, as shown in FIG. 3C, the terminal 51d is, for example, a planar electrode disposed on the surface of the integrated circuit 60, which is bonded to a planar electrode formed on the main surface 90b with a bump electrode 701 interposed therebetween. Meanwhile, the terminal 51e is, for example, a planar electrode disposed on the surface of the integrated circuit 60, which is bonded to a planar electrode formed on the main surface 90b with a bump electrode 702 interposed therebetween.

The integrated circuit 60 is formed by using complementary metal oxide semiconductor (CMOS), for example. To be more precise, the integrated circuit 60 may be manufactured in accordance with the silicon on insulator (SOI) process. Note that the integrated circuit 60 is not limited to the CMOS.

According to the above-described configuration, the set of the filters 21 and 22, and the integrated circuit 60 provided with the switch 51 are disposed separately on the two main surfaces of the module substrate 90. This configuration allows the size of the high-frequency module 1A to be reduced.

Meanwhile, the multiple external connection terminals 150 are disposed on the main surface 90b. The multiple external connection terminals 150 are electrically connected to multiple electronic components disposed on the main surfaces 90a and 90b with via conductors, planar conductors, and the like formed at the module substrate 90 and interposed therebetween. Copper electrodes can be used as the multiple external connection terminals 150. However, the multiple external connection terminals 150 are not limited thereto. For example, solder electrodes may be used as the multiple external connection terminals 150. The multiple external connection terminals 150 include the high-frequency output terminals 111 to 115 and the antenna connection terminals 101 and 102 shown in FIG. 1. Meanwhile, some of the multiple external connection terminals 150 are set to the ground potential.

Here, as shown in FIG. 3C, a distance D1 between the input terminal 211 of the filter 21 and the terminal 51d is shorter than a distance D2 between the input terminal 221 of the filter 22 and the terminal 51e.

Note that the distance D1 is defined as the shortest distance between the input terminal 211 and the terminal 51d, and the distance D2 is defined as the shortest distance between the input terminal 221 and the terminal 51e.

According to this configuration, a length of wiring to connect the filter 21, which is used in the first mode to simultaneously transmit the signal in the first band and the signal in the second band being different from the first band, to the switch 51 can be set smaller than a length of wiring to connect the filter 22, which is used only in the third mode to transmit the signal in the first band, to the switch 51. This configuration can therefore reduce parasitic capacitance of the wiring that connects the filter 21 to the switch 51. As a consequence, the signal in the first band may be prevented from being passed through the wiring that connects the filter 21 to the switch 51 and interfering with the signal in the second band, thereby deteriorating reception sensitivity of the second band.

Meanwhile, as shown in FIG. 3C, the filter 21 overlaps the antenna SW unit 61 in plan view of the module substrate 90.

This configuration makes it possible to shorten the wiring that connects the filter 21 to the switch 51. Accordingly, the signal in the first band may be prevented from being passed through the wiring that connects the filter 21 to the switch 51 and interfering with the signal in the second band, thereby deteriorating reception sensitivity of the second band.

In the meantime, as shown in FIG. 3C, the filter 22 does not overlap the antenna SW unit 61 in plan view of the module substrate 90.

This configuration can make the length of the wiring that connects the filter 21 to the switch 51 smaller than the length of the wiring that connects the filter 22 to the switch 51.

### [5 Mounting Example of High-Frequency Module 1B According to Example 2]

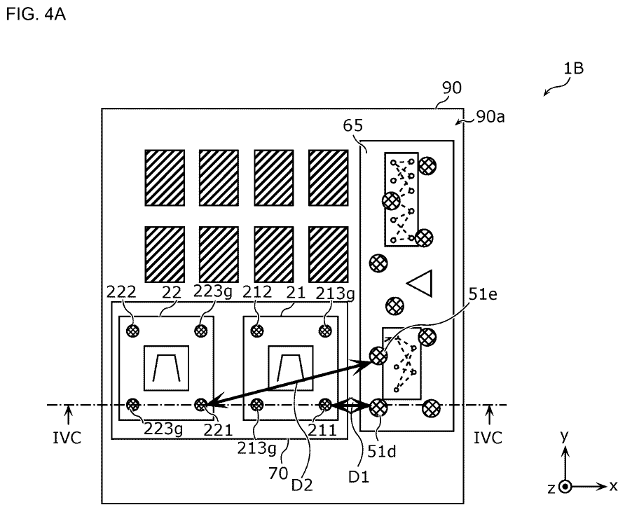

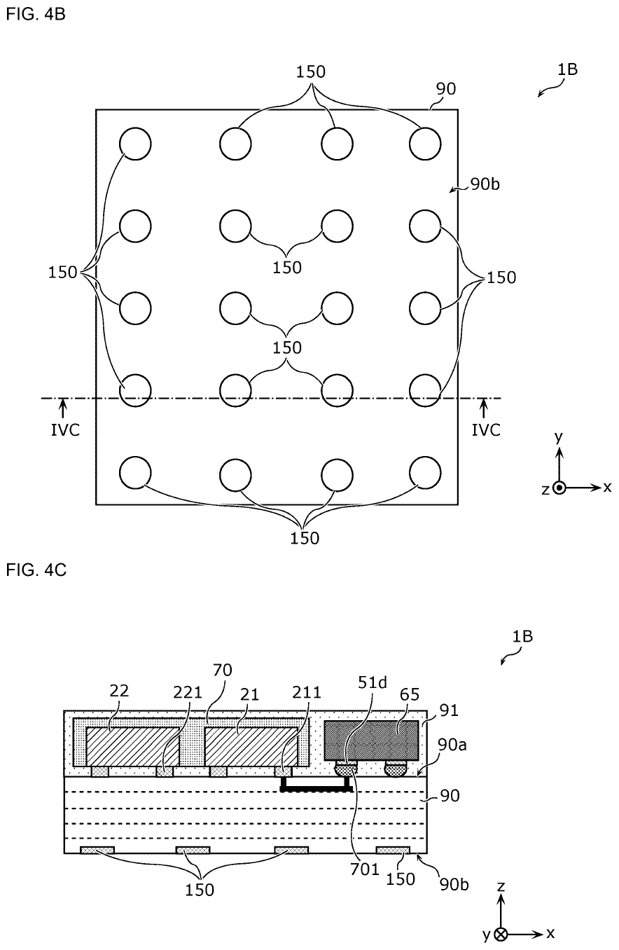

Next, as another mounting example of the high-frequency module 1, a high-frequency module 1B according to Example 2 will be described with reference to FIGS. 4A to 4C.

FIGS. 4A and 4B are plan views of the high-frequency module 1B according to the Example 2. FIG. 4C is a cross-sectional view of the high-frequency module 1B according to the Example 2. FIG. 4A is a view showing the main surface 90a side of the module substrate 90 from the positive side on the z axis. FIG. 4B is a view transparently seeing the main surface 90b side of the module substrate 90 from the positive side on the z axis. FIG. 4C shows a cross-section taken along IVC-IVC line in FIGS. 4A and 4B.

As shown in FIGS. 4A to 4C, the high-frequency module 1B includes the module substrate 90, the filters 21 and 22, an integrated circuit 65, the multiple external connection terminals 150, and the resin member 91. The high-frequency module 1A according to the Example 1 is of a double sided mounting type, whereas the high-frequency module 1B according to the present example is of a single sided mounting type. In the following, the high-frequency module 1B according to the present example will be described by mainly focusing on the different configuration from the configuration of the high-frequency module 1A according to the Example 1 while omitting the identical configuration thereto.

The resin member 91 is disposed on the main surface 90a and covers the main surface 90a and some of the multiple circuit components, thus having the function to secure reliability such as mechanical strength and moisture resistance of the aforementioned multiple circuit components.

The filters 21 and 22 are disposed on the main surface 90a. As shown in FIG. 4A, the filter 21 includes the input terminal 211, the output terminal 212, and the ground terminal 213g. The filter 22 includes the input terminal 221, the output terminal 222, and the ground terminal 223g. Each of the input terminal 211, the output terminal 212, and the ground terminal 213g is either a planar electrode or a bump electrode disposed on the surface of the filter 21. Each of the input terminal 221, the output terminal 222, and the ground terminal 223g is either a planar electrode or a bump electrode disposed on the surface of the filter 22.

An integrated circuit 70 is an example of a first integrated circuit, and includes the filters 21 and 22. When the filters 21 and 22 are acoustic wave filters, the filters 21 and 22 may be formed at a common piezoelectric substrate. For example, the piezoelectric substrate can adopt any of single crystals and ceramics of lithium tantalate (LiTaO₃), lithium niobate (LiNbO₃), aluminum nitride (AlN), and zinc oxide (ZnO). In the meantime, the filters 21 and 22 may be disposed in a single package.

Although not illustrated, the filters 11 to 13 and the inductors 41 to 48 are disposed on the main surface 90a.

The integrated circuit 65 is an example of a second integrated circuit, which is disposed on the main surface 90a. As shown in FIG. 4A, the integrated circuit 65 includes the switches 51 and 52, and the low-noise amplifiers 31 to 35. Although the integrated circuit 65 has a rectangular shape in plan view of the module substrate 90 in FIG. 4A, the shape of the integrated circuit 65 is not limited thereto.

As shown in FIG. 4A, each of the terminals 51d and 51e of the switch 51 is an external connection terminal disposed on a surface of the integrated circuit 65. To be more precise, as shown in FIG. 4C, the terminal 51d is, for example, a planar electrode disposed on the surface of the integrated circuit 65, which is bonded to a planar electrode formed on the main surface 90a with the bump electrode 701 interposed therebetween. Meanwhile, the terminal 51e is, for example, a planar electrode disposed on the surface of the integrated circuit 65, which is bonded to a planar electrode formed on the main surface 90a with a bump electrode interposed therebetween.

The integrated circuit 65 is formed by using the CMOS, for example. To be more precise, the integrated circuit 65 may be manufactured in accordance with the SOI process. Note that the integrated circuit 65 is not limited to the CMOS.

According to the above-described configuration, the filters 21 and 22 are included in the single integrated circuit 70, and the switches 51 and 52 as well as the low-noise amplifiers 31 to 35 are included in the single integrated circuit 65. This configuration allows the size of the high-frequency module 1B to be reduced.

Here, as shown in FIG. 4A, the distance D1 between the input terminal 211 of the filter 21 and the terminal 51d is shorter than the distance D2 between the input terminal 221 of the filter 22 and the terminal 51e.

Note that the distance D1 is defined as the shortest distance between the input terminal 211 and the terminal 51d, and the distance D2 is defined as the shortest distance between the input terminal 221 and the terminal 51e.

According to this configuration, the length of the wiring to connect the filter 21, which is used in the first mode to simultaneously transmit the signal in the first band and the signal in the second band being different from the first band, to the switch 51 can be set smaller than the length of the wiring to connect the filter 22, which is used only in the third mode to transmit the signal in the first band, to the switch 51. This configuration can therefore reduce the parasitic capacitance of the wiring that connects the filter 21 to the switch 51. As a consequence, the signal in the first band may be prevented from being passed through the wiring that connects the filter 21 to the switch 51 and interfering with the signal in the second band, thereby deteriorating reception sensitivity of the second band.

Meanwhile, the filter 21 is preferably disposed adjacent to the switch 51.

According to this configuration, the length of the wiring to connect the filter 21, which is used in the first mode to simultaneously transmit the signal in the first band and the signal in the second band being different from the first band, to the switch 51 can be reduced. Thus, the parasitic capacitance of the wiring that connects the filter 21 to the switch 51 may be reduced. Accordingly, the signal in the first band may be prevented from being passed through the wiring that connects the filter 21 to the switch 51 and interfering with the signal in the second band, thereby deteriorating reception sensitivity of the second band.

### [6 Mounting Example of High-Frequency Module 1C According to Example 3]

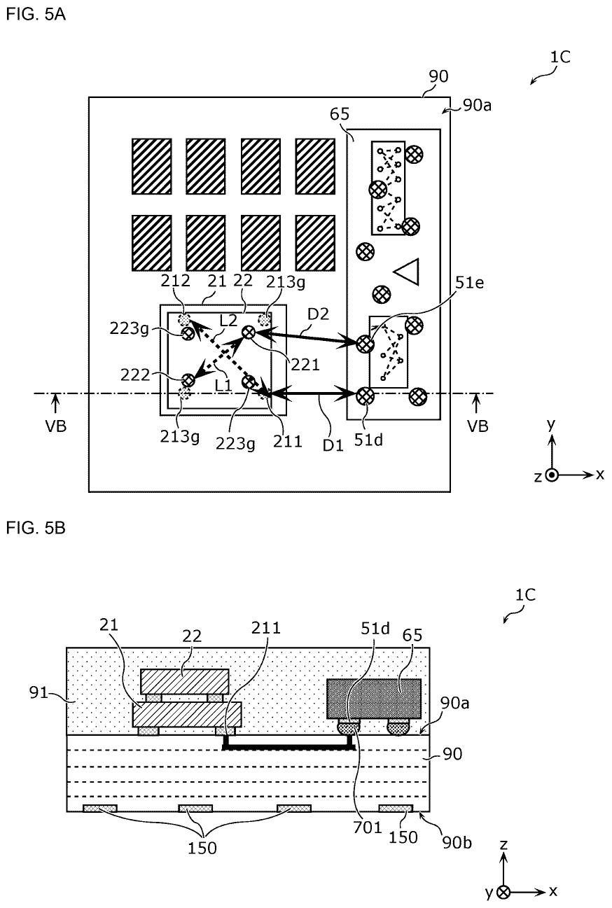

Next, as another mounting example of the high-frequency module 1, a high-frequency module 1C according to Example 3 will be described with reference to FIGS. 5A and 5B.

FIG. 5A is a plan view of the high-frequency module 1C according to the Example 3. FIG. 5B is a cross-sectional view of the high-frequency module 1C according to the Example 3. FIG. 5A is a view showing the main surface 90a side of the module substrate 90 from the positive side on the z axis. FIG. 5B shows a cross-section taken along VB-VB line in FIG. 5A.

As shown in FIGS. 5A and 5B, the high-frequency module 1C includes the module substrate 90, the filters 21 and 22, the integrated circuit 65, the multiple external connection terminals 150, and the resin member 91. As compared to the high-frequency module 1B according to the Example 2, the high-frequency module 1C according to the present example has a different layout configuration of the filters 21 and 22. In the following, the high-frequency module 1C according to the present example will be described by mainly focusing on the different configuration from the configuration of the high-frequency module 1B according to the Example 2 while omitting the identical configuration thereto.

The filters 21 and 22 are disposed on the main surface 90a. As shown in FIG. 5B, the filter 21 and the filter 22 are stacked and the filter 21 is disposed between the module substrate 90 and the filter 22.

According to this configuration, since the filter 21 and the filter 22 are disposed in a stacked manner on the main surface 90a, the size of the high-frequency module 1C may be reduced.

As shown in FIG. 5A, the filter 21 includes the input terminal 211, the output terminal 212, and the ground terminal 213g. The filter 22 includes the input terminal 221, the output terminal 222, and the ground terminal 223g. Each of the input terminal 211, the output terminal 212, and the ground terminal 213g is either a planar electrode or a bump electrode disposed on the surface of the filter 21. Each of the input terminal 221, the output terminal 222, and the ground terminal 223g is either a planar electrode or a bump electrode disposed on the surface of the filter 22.

Here, as shown in FIG. 5A, the distance D1 between the input terminal 211 of the filter 21 and the terminal 51d is shorter than the distance D2 between the input terminal 221 of the filter 22 and the terminal 51e.

Note that the distance D1 is defined as the shortest distance between the input terminal 211 and the terminal 51d, and the distance D2 is defined as the shortest distance between the input terminal 221 and the terminal 51e.

According to this configuration, the length of the wiring to connect the filter 21, which is used in the first mode to simultaneously transmit the signal in the first band and the signal in the second band being different from the first band, to the switch 51 can be set smaller than the length of the wiring to connect the filter 22, which is used only in the third mode to transmit the signal in the first band, to the switch 51. This configuration can therefore reduce the parasitic capacitance of the wiring that connects the filter 21 to the switch 51. As a consequence, the signal in the first band may be prevented from being passed through the wiring that connects the filter 21 to the switch 51 and interfering with the signal in the second band, thereby deteriorating reception sensitivity of the second band.

In the meantime, in plan view of the module substrate 90 as shown in FIG. 5A, an imaginary line segment L2 that connects the input terminal 211 to the output terminal 212 of the filter 21 crosses an imaginary line segment L1 that connects the input terminal 221 to the output terminal 222 of the filter 22.

According to this configuration, since the imaginary line segments L1 and L2 cross each other instead of extending in parallel, the parasitic capacitance generated between the wiring that connects the input terminal 211 to the output terminal 212 of the filter 21 and the wiring that connects the input terminal 221 to the output terminal 222 of the filter 22 may be reduced. Moreover, the imaginary line segments L1 and L2 cross each other in plan view as mentioned above instead of being located away from each other. Accordingly, the size of a multilayer body of the filters 21 and 22 can be reduced. As a consequence, the size of the high-frequency module 1C may be reduced while suppressing the parasitic capacitance to be generated by the filters 21 and 22.

### [7 Effects and Others]

As described above, the high-frequency module 1 according to the present embodiment includes the module substrate 90, the filters 21 and 22 disposed at the module substrate 90 and having the passband including the reception band of the first band, the filter 11 disposed at the module substrate 90 and having the passband including the reception band of the second band, and the switch 51 disposed at the module substrate 90 and provided with the terminal 51d to be connected to the input terminal 211 of the filter 21, the terminal 51e to be connected to the input terminal 221 of the filter 22, the terminal 51c to be connected to the input terminal of the filter 11, the terminal 51a to be connected to the antenna connection terminal 101, and the terminal 51b to be connected to the antenna connection terminal 102. The high-frequency module 1 has the first mode to simultaneously transmit the reception signal in the first band being passed through the filter 21 without being passed through the filter 22 and the reception signal in the second band being passed through the filter 11, the second mode to transmit the reception signal in the first band being passed through the filter 21 without being passed through the filter 22 alone, and the third mode to simultaneously transmit the reception signal in the first band being passed through the filter 21 and the reception signal in the first band being passed through the filter 22. The distance between the input terminal 211 and the terminal 51d is shorter than the distance between the input terminal 221 and the terminal 51e.

According to this configuration, the length of the wiring to connect the filter 21, which is used in the first mode to simultaneously transmit the signal in the first band and the signal in the second band, to the switch 51 can be set smaller than the length of the wiring to connect the filter 22, which is used only in the third mode to transmit the signal in the first band, to the switch 51. This configuration can therefore reduce parasitic capacitance of the wiring that connects the filter 21 to the switch 51. As a consequence, the signal in the first band may be prevented from being passed through the wiring that connects the filter 21 to the switch 51 and interfering with the signal in the second band, thereby deteriorating reception sensitivity of the second band.

Meanwhile, the high-frequency module 1 according to the present embodiment includes the module substrate 90, the filters 21 and 22 disposed at the module substrate 90 and having the passband including the reception band of the first band, the filter 11 disposed at the module substrate 90 and having the passband including the reception band of the second band, and the switch 51 disposed at the module substrate 90 and provided with the terminal 51d to be connected to the input terminal 211 of the filter 21, the terminal 51e to be connected to the input terminal 221 of the filter 22, the terminal 51c to be connected to the input terminal of the filter 11, the terminal 51a to be connected to the antenna connection terminal 101, and the terminal 51b to be connected to the antenna connection terminal 102. The high-frequency module 1 has the first mode to simultaneously receive the signal in the first band and the signal in the second band while connecting the terminal 51d to the terminal 51b, connecting the terminal 51c to the terminal 51a, and not connecting the terminal 51e to the terminal 51a or 51b, the second mode to receive the signal in the first band while connecting the terminal 51d to the terminal 51b, not connecting the terminal 51e to the terminal 51a or 51b, and not connecting the terminal 51c to the terminal 51a or 51b, and the third mode to simultaneously receive the signal in the first band and the signal in the first band while connecting the terminal 51d to the terminal 51a, connecting the terminal 51e to the terminal 51b, and not connecting the terminal 51c to the terminal 51a or 51b. The distance between the input terminal 211 and the terminal 51d is shorter than the distance between the input terminal 221 and the terminal 51e.

According to this configuration, the signal in the first band may be prevented from being passed through the wiring that connects the filter 21 to the switch 51 and interfering with the signal in the second band, thereby deteriorating reception sensitivity of the second band.

Meanwhile, in the high-frequency module 1A according to the Example 1, for example, the module substrate 90 includes the main surfaces 90a and 90b opposed to each other. The filters 21 and 22 are disposed on the main surface 90a, and the switch 51 is disposed on the main surface 90b.

According to this configuration, the set of the filters 21 and 22 and the switch 51 are disposed separately at the two main surfaces of the module substrate 90. Thus, the size of the high-frequency module 1A may be reduced.

In the meantime, in the high-frequency module 1A, for example, the filter 21 overlaps the switch 51 in plan view of the module substrate 90.

According to this configuration, the wiring that connects the filter 21 to the switch 51 may be shortened. Thus, the signal in the first band may be prevented from being passed through the wiring that connects the filter 21 to the switch 51 and interfering with the signal in the second band, thereby deteriorating reception sensitivity of the second band.

Meanwhile, in the high-frequency module 1A, for example, the filter 22 does not overlap the switch 51 in plan view of the module substrate 90.

According to this configuration, the length of the wiring that connects the filter 21 to the switch 51 may be smaller than the length of the wiring that connects the filter 22 to the switch 51.

In the meantime, in the high-frequency module 1B according to the Example 2, for example, the filters 21 and 22 as well as the switch 51 are disposed on the main surface 90a.

Meanwhile, in the high-frequency module 1B, for example, the filter 21 and the switch 51 are disposed adjacent to each other.

According to these configurations, the length of the wiring that connects the filter 21 to the switch 51 may be reduced, thus reducing the parasitic capacitance of the wiring that connects the filter 21 to the switch 51. As a consequence, the signal in the first band may be prevented from being passed through the wiring that connects the filter 21 to the switch 51 and interfering with the signal in the second band, thereby deteriorating reception sensitivity of the second band.

In the meantime, in the high-frequency module 1B, for example, the filter 21 and the filter 22 are included in the integrated circuit 70.

According to this configuration, the size of the high-frequency module 1B may be reduced.

Meanwhile, in the high-frequency module 1B, for example, each of the input terminals 211 and 221 is disposed on the surface of the integrated circuit 70.

According to this configuration, the input terminals 211 and 221 can be formed into the external connection terminals.

In the meantime, in the high-frequency module 1C according to the Example 3, for example, the filter 21 and the filter 22 are stacked, and the filter 21 is disposed between the module substrate 90 and the filter 22.

According to this configuration, since the filter 21 and the filter 22 are disposed in a stacked manner, the size of the high-frequency module 1C may be reduced.

Meanwhile, in the high-frequency module 1C, for example, the imaginary line segment L2 that connects the input terminal 211 to the output terminal 212 crosses the imaginary line segment L1 that connects the input terminal 221 to the output terminal 222 in plan view of the module substrate 90.

According to this configuration, since the imaginary line segments L1 and L2 cross each other instead of extending in parallel, the parasitic capacitance generated between the wiring that connects the input terminal 211 to the output terminal 212 of the filter 21 and the wiring that connects the input terminal 221 to the output terminal 222 of the filter 22 may be reduced. Moreover, since the imaginary line segments L1 and L2 are not disposed away from each other in plan view as mentioned above, the size of a multilayer body of the filters 21 and 22 can be reduced. As a consequence, the size of the high-frequency module 1C may be reduced while suppressing the parasitic capacitance to be generated by the filters 21 and 22.

In the meantime, in the high-frequency modules 1A to 1C, for example, the switch 51 is included in the integrated circuit 60 (or 65).

According to this configuration, the size of the high-frequency modules 1A to 1C may be reduced.

Meanwhile, in the high-frequency modules 1A to 1C, for example, each of the terminals 51d and 51e is disposed on the surface of the integrated circuit 60 (or 65).

According to this configuration, it is possible to form the terminals 51d and 51e into the external connection terminals.

In the meantime, in the high-frequency module 1, for example, the third mode is the communication mode for MIMO.

Meanwhile, the high-frequency module 1 further includes the inductor 47 which is connected between the ground and the path that connects the input terminal 211 to the terminal 51d, and the inductor 48 which is connected between the ground and the path that connects the input terminal 221 to the terminal 51e, for example.

According to this configuration, impedance matching between the filter 21 and the switch 51, and impedance matching between the filter 22 and the switch 51 may be performed.

In the meantime, in the high-frequency module 1, for example, the inductance value of the inductor 47 is smaller than the inductance value of the inductor 48.

According to this configuration, the impedance matching between the switch 51 and the filter 21 that is used in the first mode, the second mode, and the third mode, and the impedance matching between the switch 51 and the filter 22 that is used only in the third mode, may respectively be optimized.

Meanwhile, the high-frequency module 1 further includes the low-noise amplifier 34 connected to the output terminal 212, the low-noise amplifier 35 connected to the output terminal 222, and the low-noise amplifier 31 connected to the output terminal of the filter 11, for example.

According to this configuration, a high-frequency signal in the first band and a high-frequency signal in the second band may be amplified.

In the meantime, in the high-frequency module 1, for example, the filter 22 has the passband that includes the first band and the third band that at least partially overlaps the first band.

According to this configuration, the filter 22 passes through the high-frequency signal in the first band and a high-frequency signal in the third band. Thus, the size of the high-frequency module 1 can be reduced.

Meanwhile, in the high-frequency module 1, for example, the third band is Band 53 for LTE or n53 for 5GNR.

According to this configuration, it is possible to deal with reception of the signal of Band 53 for LTE or n53 for 5GNR.

In the meantime, in the high-frequency module 1, for example, the first band is any of Band 41, Band 77, and Band 78 for LTE as well as n41, n77, and n78 for 5GNR. Meanwhile, the second band is any of Band 1, Band 3, and Band 40 for LTE as well as n1, n3, and n40 for 5GNR.

According to this configuration, it is possible to deal with reception of the signal of the bands for LTE and/or 5GNR.

### OTHER EMBODIMENTS

The high-frequency module according to a certain aspect of the present disclosure has been described above based on an embodiment. It is to be understood, however, that the high-frequency module according to the present disclosure is not limited to the above-described embodiment. The present disclosure also encompasses other embodiments that are realized by combining any constituents in the above-described embodiment, modified examples obtained by subjecting the above-described embodiment to various modifications conceived of by the person skilled in the art within the range nor departing from the gist of the present disclosure, and a variety of equipment that embeds the above-described high-frequency module.

For example, in the circuit configuration of the high-frequency module according to the above-described embodiment, other circuit elements, wiring, and the like may be inserted between the respective circuit elements as well as between the paths that connect signal paths as disclosed in the drawings.

Meanwhile, the high-frequency module 1 does not include a transmission path in the above-described embodiment. Nevertheless, the high-frequency module 1 may include the transmission path.

The characteristics of the high-frequency module described above based on the embodiment will be shown below.

<1> A high-frequency module including:
a module substrate;
a first filter and a second filter disposed at the module substrate and having a passband including a reception band of a first band;
a third filter disposed at the module substrate and having a passband including a reception band of a second band; and
a switch disposed at the module substrate and including
   a first terminal to be connected to an input terminal of the first filter,
   a second terminal to be connected to an input terminal of the second filter,
   a third terminal to be connected to an input terminal of the third filter,
   a fourth terminal to be connected to a first antenna connection terminal, and
   a fifth terminal to be connected to a second antenna connection terminal, in which
the high-frequency module has
   a first mode to simultaneously transmit a reception signal in the first band being passed through the first filter without being passed through the second filter and a reception signal in the second band being passed through the third filter,
   a second mode to transmit a reception signal in the first band being passed through the first filter without being passed through the second filter alone, and
   a third mode to simultaneously transmit a reception signal in the first band being passed through the first filter and a reception signal in the first band being passed through the second filter, and
a distance between the input terminal of the first filter and the first terminal is shorter than a distance between the input terminal of the second filter and the second terminal.

<2> A high-frequency module including:
a module substrate;
a first filter and a second filter disposed at the module substrate and having a passband including a reception band of a first band;
a third filter disposed at the module substrate and having a passband including a reception band of a second band; and
a switch disposed at the module substrate and including
   a first terminal to be connected to an input terminal of the first filter,
   a second terminal to be connected to an input terminal of the second filter,
   a third terminal to be connected to an input terminal of the third filter,
   a fourth terminal to be connected to a first antenna connection terminal, and
   a fifth terminal to be connected to a second antenna connection terminal, in which
the high-frequency module has
   a first mode to simultaneously receive a signal in the first band and a signal in the second band while connecting the first terminal to the fourth terminal or the fifth terminal, connecting the third terminal to the fourth terminal or the fifth terminal, and not connecting the second terminal to the fourth terminal or the fifth terminal,
   a second mode to receive a signal in the first band while connecting the first terminal to the fourth terminal or the fifth terminal, not connecting the second terminal to the fourth terminal or the fifth terminal, and not connecting the third terminal to the fourth terminal or the fifth terminal, and
   a third mode to simultaneously receive a signal in the first band and a signal in the first band while connecting the first terminal to the fourth terminal or the fifth terminal, connecting the second terminal to the fourth terminal or the fifth terminal, and not connecting the third terminal to the fourth terminal or the fifth terminal, and
a distance between the input terminal of the first filter and the first terminal is shorter than a distance between the input terminal of the second filter and the second terminal.

<3> The high-frequency module according to <1> or <2>, in which
the module substrate includes a first main surface and a second main surface opposed to each other,
the first filter and the second filter are disposed on the first main surface, and
the switch is disposed on the second main surface.

<4> The high-frequency module according to <3>, in which the first filter overlaps the switch in plan view of the module substrate.

<5> The high-frequency module according to <4>, in which the second filter does not overlap the switch in plan view of the module substrate.

<6> The high-frequency module according to <1> or <2>, in which
the module substrate includes a first main surface and a second main surface opposed to each other, and
the first filter, the second filter, and the switch are disposed on the first main surface.

<7> The high-frequency module according to <6>, in which the first filter and the switch are disposed adjacent to each other.

<8> The high-frequency module according to any one of <1> to <7>, in which the first filter and the second filter are included in a first integrated circuit.

<9> The high-frequency module according to <8>, in which each of the input terminal of the first filter and the input terminal of the second filter is disposed on a surface of the first integrated circuit.

<10> The high-frequency module according to any one of <1> to <7>, in which
the first filter and the second filter are stacked, and
the first filter is disposed between the module substrate and the second filter.

<11> The high-frequency module according to <10>, in which an imaginary line segment that connects the input terminal of the first filter to an output terminal of the first filter crosses an imaginary line segment that connects the input terminal of the second filter to an output terminal of the second filter in plan view of the module substrate.

<12> The high-frequency module according to any one of <1> to <11>, in which the switch is included in a second integrated circuit.

<13> The high-frequency module according to <12>, in which each of the first terminal and the second terminal is disposed on a surface of the second integrated circuit.

<14> The high-frequency module according to any one of <1> to <13>, in which the third mode is a communication mode for Multiple-Input and Multiple-Output (MIMO).

<15> The high-frequency module according to any one of <1> to <14>, further including:
a first inductor connected between a ground and a path that connects the input terminal of the first filter to the first terminal; and
a second inductor connected between the ground and a path that connects the input terminal of the second filter to the second terminal.

<16> The high-frequency module according to <15>, in which an inductance value of the first inductor is smaller than an inductance value of the second inductor.

<17> The high-frequency module according to any one of <1> to <16>, further including:
a first low-noise amplifier connected to an output terminal of the first filter;
a second low-noise amplifier connected to an output terminal of the second filter; and
a third low-noise amplifier connected to an output terminal of the third filter.

<18> The high-frequency module according to any one of <1> to <17>, in which the second filter has a passband that includes the first band and the third band that at least partially overlaps the first band.

<19> The high-frequency module according to <18>, in which the third band is Band 53 for LTE or n53 for 5GNR.

<20> The high-frequency module according to any one of <1> to <19>, in which
the first band is any of Band 41, Band 77, and Band 78 for Long Term Evolution (LTE) as well as n41, n77, and n78 for 5th Generation New Radio (5GNR), and
the second band is any of Band 1, Band 3, and Band 40 for LTE as well as n1, n3, and n40 for 5GNR.

### INDUSTRIAL APPLICABILITY

The present invention is widely applicable to communication equipment such as cellular phones as a high-frequency module to be disposed at a front end unit.

### REFERENCE SIGNS LIST

1, 1A, 1B, 1C high-frequency module
2a, 2b antenna
3 RFIC
4 BBIC
5 communication device
11, 12, 13, 21, 22 filter
31, 32, 33, 34, 35 low-noise amplifier
41, 42, 43, 44, 45, 46, 47, 48 inductor
51, 52 switch
51a, 51b, 51c, 51d, 51e terminal
55 DTC
60, 65, 70 integrated circuit
61 antenna SW unit
62 LNA unit
90 module substrate
90a, 90b main surface
91, 92 resin member
101, 102 antenna connection terminal
111, 112, 113, 114, 115 high-frequency output terminal
150 external connection terminal
211, 221 input terminal
212, 222 output terminal
213g, 223g ground terminal
701, 702 bump electrode
D1, D2 distance
L1, L2 imaginary line segment

1. A high-frequency module comprising:
a module substrate;
a first filter having a first input terminal and a passband including a reception band of a first band;
a second filter having a second input terminal a passband including the reception band of the first band;
a third filter having a third input terminal having a passband including a reception band of a second band; and
a switch including
a first terminal to be connected to the first input terminal,
a second terminal to be connected to the second input terminal,
a third terminal to be connected to the third input terminal,
a fourth terminal to be connected to a first antenna connection terminal, and
a fifth terminal to be connected to a second antenna connection terminal, wherein
the first filter, the second filter, the third filter and the switch are on the module substrate, and
the high-frequency module is configurable to operate in:
a first mode to simultaneously transmit a first band reception signal passing through the first filter and a second band reception signal in the second band passing through the third filter, the first band reception signal passing not being passed through the second filter,
a second mode to transmit only the first band reception signal passing through the first filter, and
a third mode to simultaneously transmit a first instance of the first band reception signal passing through the first filter and a second instance of the first band reception signal passing through the second filter, and
a distance between the first input terminal and the first terminal of the switch is shorter than a distance between the second input terminal and the second terminal of the switch.

2. The high-frequency module according to claim 1, wherein:
in the first mode, the switch connects the first terminal to the fourth terminal or the fifth terminal, the third terminal to the fourth terminal or the fifth terminal, and does not connect the second terminal to the fourth terminal or the fifth terminal,
in the second mode, the switch connects the first terminal to the fourth terminal or the fifth terminal, does not connect the second terminal to the fourth terminal or the fifth terminal, and does not connect the third terminal to the fourth terminal or the fifth terminal, and
in the third mode, the switch connects the first terminal to the fourth terminal or the fifth terminal, connects the second terminal to the fourth terminal or the fifth terminal, and does not connect the third terminal to the fourth terminal or the fifth terminal.

3. The high-frequency module according to claim 1, wherein
the module substrate includes a first main surface and a second main surface opposed to each other,
the first filter and the second filter are on the first main surface, and
the switch is on the second main surface.

4. The high-frequency module according to claim 3, wherein the first filter overlaps the switch in plan view of the module substrate.

5. The high-frequency module according to claim 4, wherein the second filter does not overlap the switch in plan view of the module substrate.

6. The high-frequency module according to claim 1, wherein
the module substrate includes a first main surface and a second main surface opposed to each other, and
the first filter, the second filter, and the switch are disposed on the first main surface.

7. The high-frequency module according to claim 6, wherein the first filter and the switch are disposed adjacent to each other.

8. The high-frequency module according to claim 1, wherein the first filter and the second filter are included in a first integrated circuit.

9. The high-frequency module according to claim 8, wherein each of the first input terminal and the second input terminal is disposed on a surface of the first integrated circuit.

10. The high-frequency module according to claim 1, wherein
the first filter and the second filter are stacked, and
the first filter is disposed between the module substrate and the second filter.

11. The high-frequency module according to claim 10, wherein an imaginary line segment that connects the first input terminal to an output terminal of the first filter crosses an imaginary line segment that connects the second input terminal to an output terminal of the second filter in plan view of the module substrate.

12. The high-frequency module according to claim 1, wherein the switch is included in a second integrated circuit.

13. The high-frequency module according to claim 12, wherein each of the first terminal and the second terminal is disposed on a surface of the second integrated circuit.

14. The high-frequency module according to of claim 1, wherein the third mode is a communication mode for Multiple-Input and Multiple-Output (MIMO).

15. The high-frequency module according to claim 1, further comprising:
a first inductor connected between a ground and a path that connects the first input terminal to the first terminal of the switch; and
a second inductor connected between the ground and a path that connects the second input terminal to the second terminal of the switch.

16. The high-frequency module according to claim 15, wherein an inductance value of the first inductor is smaller than an inductance value of the second inductor.

17. The high-frequency module according to claim 1, further comprising:
a first low-noise amplifier connected to an output terminal of the first filter;
a second low-noise amplifier connected to an output terminal of the second filter; and
a third low-noise amplifier connected to an output terminal of the third filter.

18. The high-frequency module according to claim 1, wherein the second filter has a passband that includes the first band and a third band that at least partially overlaps the first band.

19. The high-frequency module according to claim 1, wherein
the first band is any of Band 41, Band 77, and Band 78 for Long Term Evolution (LTE) as well as n41, n77, and n78 for 5th Generation New Radio (5GNR), and
the second band is any of Band 1, Band 3, and Band 40 for LTE as well as n1, n3, and n40 for 5GNR.

20. A high-frequency module, comprising:
a module substrate;
a switch having a first terminal and a second terminal;
a first filter having a first input terminal connected to the first terminal of the switch and a passband including a reception band of a first frequency band; and
a second filter having a second input terminal connected to the second terminal of the switch and a passband including the reception band of the first frequency band, wherein
the first filter, the second filter, and the switch are on the module substrate, and
the first filter is physically positioned relative to the switch such that a first signal path length between the first input terminal and the first terminal is shorter than a second signal path length between the second input terminal and the second terminal.
